(19) United States
(12) Patent Application Publication
(10) Pub. No.: US 2023/0376980 A1
(43) Pub. Date: Nov. 23, 2023

(54) SYSTEM AND METHOD FOR PREDICTING GIG SERVICE IN ACCORDANCE WITH SPATIO-TEMPORAL CHARACTERISTICS

(71) Applicant: ENTERPRISE BLOCKCHAIN CO., LTD., Seoul (KR)

(72) Inventors: Jihyun LEE, Yongin-si (KR); Youngseok HAN, Hwaseong-si (KR); Seonghyuck YOO, Seoul (KR); Yongwook KIM, Seoul (KR); Junsup LEE, Seoul (KR)

(73) Assignee: ENTERPRISE BLOCKCHAIN CO., LTD., Seoul (KR)

(21) Appl. No.: 18/034,502

(22) PCT Filed: Oct. 20, 2021
(86) PCT No.: PCT/KR2021/014676

§ 371 Date: Apr. 28, 2023

(30) Foreign Application Priority Data
Oct. 30, 2020 (KR) 10-2020-0143120

(51) Int. Cl. G06Q 30/0202; G06Q 30/0204

(52) U.S. Cl. CPC G06Q 30/0202; G06Q 30/0205

(57) ABSTRACT

Disclosed are a system and method for predicting a gig service in accordance with spatio-temporal characteristics, the system comprising: a data acquisition unit for acquiring gig service completion data and gig service request data generated in a preset time interval or a preset space interval; a prediction unit for generating prediction data associated with the number of gig service requests to be generated in a specific time interval or a specific space interval and the number of gig workers who will provide the gig service, by means of the gig service request data and/or the gig service completion data; a load ratio determination unit for determining a service load ratio of number of gig workers to number of gig service requests in the specific time interval or the specific space interval, by means of the generated request data; and a load ratio providing unit transmitting the service load ratio to an external terminal.

### TECHNICAL FIELD

The present invention relates to a gig service prediction system and a method thereof according to spatio-temporal characteristics, and more particularly, the gig service prediction system and method according to spatio-temporal characteristics, which can predict the number of gig service requests to occur in a specific time and space and the number of gig workers to provide the gig service, thereby enabling efficient placement of gigs.

### BACKGROUND ART

Along with the development of digital technology, the world is more connected over digital networks, and as the so-called inter-industry convergence and fusion become more active through the 4th Industrial Revolution, a new economic paradigm called ‘Gig Economy’ is attracting attention. The gig economy is a form of economy in which people are hired as needed at respective industrial sites, contracted temporarily, and entrusted with them. Here, the term ‘gig’ generally refers to a fixed-term work traded on a digital platform, but it has recently changed to mean a service provider (or gig worker) that provides requested services in a form of a short-term contract with an online platform company. Throughout the present disclosure, a worker who temporarily engages in a fixed-term work activity will be referred to as a ‘gig’ or a ‘gig service provider’. Such a gig service is of a fixed-term work service that is traded on a digital platform based on a temporary service contract as needed, such as e.g., cleaning agency or delivery agency, and the disclosure is not limited to a specific form of work activity.

According to the gig economy, companies may utilize gigs with desired capabilities when needed, which is very advantageous in terms of securing labor flexibility and reducing labor costs. Further, the gigs may have the advantage of being able to work when they desire to, thus making their own time management easier and leading to low entry barriers to the gig-related industries. In particular, the transition to the society in which every aspect of daily life is performed in an untact (i.e., non-face-to-face) manner is accelerated due to the transition to the digital age and the concerns about virus infection, and therefore, the gig services are also explosively increasing.

However, the current available platform for the gig services may only provide the functions of spreading the gig service request generated to all gigs or recommending services that can be processed grouping together amongst the service requests generated. In particular, since there are not always as many gigs as needed for each region, the gigs may be crowded at a specific time or region, or there may be often a shortage of the gigs as required. In such a circumstance, there is a problem in that quality of services may not be provided to every gig service requester, and the gigs providing the corresponding services might be unable to establish their working plans and future schedule of working in a most efficient manner.

### DETAILED DESCRIPTION OF THE INVENTION

### Technical Problem

The present invention has been devised to cope with the above-described technical problems, and aims to substantially make up for various problems caused by limitations and disadvantages in the prior art. The present invention provide a gig service prediction system and its method for efficiently deploy gigs by predicting the demand for gig services and the number of gigs, based on spatio-temporal characteristics, and provide a computer-readable recording medium in which a program for executing the method is recorded.

### Technical Solution

According to an embodiment of the present invention, a gig service prediction method according to spatio-temporal characteristics includes: obtaining gig service request data and gig service completion data, generated in a preset time interval or a preset space interval; generating prediction data on the number of gig service requests to occur in a specific time interval or a specific space interval and the number of gigs (workers) to provide the gig service, using at least one of the gig service request data and the gig service completion data; determining a service load rate representing the number of gig service requests in comparison to the number of gigs in the specific time interval or the specific space interval, using the generated prediction data; and transmitting the service load rate to an external terminal.

According to an embodiment of the present invention, the gig service request data includes at least one of service type, service request time, service request area, service management spot, service requester information, history information of the service requester, or service feedback information.

According to an embodiment of the present invention, the gig service completion data includes at least one of service type, service request time, service request area, service completion time, time for gig assignment, assigned gig information, history information of assigned gig, service management spot, or service feedback information.

According to an embodiment of the present invention, the generating of the prediction data includes analyzing a degree of association between at least one of the gig service request data and the gig service completion data and external data, and assigning a weight to the prediction data on the number of gig service requests to occur in the specific time interval or the specific space interval and the number of gigs to provide the gig service, based on the degree of association.

According to an embodiment of the present invention, the external data includes at least one of topographic information of the specific space interval, resident population information in the specific space interval, or weather information and holiday information in the specific time interval or the specific space interval.

According to an embodiment of the present invention, the gig service prediction method further includes receiving spatio-temporal information and the number of gigs assigned to the spatio-temporal information from a first terminal, and generating gig placement data based on the spatio-temporal information and the number of gigs.

According to an embodiment of the present invention, the gig service prediction method further includes updating the prediction data and the service load rate, based on the gig placement data.

According to an embodiment of the present invention, the gig service prediction method further includes receiving spatio-temporal information and gig service information to be provided to the spatio-temporal information from a second terminal, and generating gig reservation data based on the spatio-temporal information and the gig service information.

According to an embodiment of the present invention, the gig service prediction method further includes receiving gig completion data including a gig service completion time from the second terminal.

According to an embodiment of the present invention, the gig service prediction method further includes updating the prediction data and the service load rate, based on the gig reservation data or the gig completion data.

Further, according to an embodiment of the present invention, a computer-readable recording medium in which a program for performing the method is recorded is provided.

Further, according to an embodiment of the present invention, a gig service prediction system according to spatio-temporal characteristics includes: a data acquisition unit obtaining gig service request data and gig service completion data generated in a preset time interval or a preset space interval; a prediction unit generating prediction data on the number of gig service requests to occur in a specific time interval or a specific space interval and the number of gigs to provide the gig service, using at least one of the gig service request data and the gig service completion data; a load rate determination unit determining a service load rate representing the number of gig service requests in comparison to the number of gigs in the specific time interval or the specific space interval, using the generated prediction data; and a load rate provision unit transmitting the service load rate to an external terminal.

According to an embodiment of the present invention, the gig service request data includes at least one of service type, service request time, service request area, service management spot, service requester information, history information of service requester, or service feedback information.

According to an embodiment of the present invention, the gig service completion data includes at least one of service type, service request time, service request area, service completion time, time for gig assignment, assigned gig information, history information of assigned gig, service management spot, or service feedback information.

According to an embodiment of the present invention, the prediction unit is configured to analyze a degree of association between at least one of the gig service request data and the gig service completion data and external data, and assign a weight to prediction data on the number of gig service requests to occur in the specific time interval or the specific space interval and the number of gigs to provide the gig service, based on the degree of association.

According to an embodiment of the present invention, the external data includes at least one of topographic information of the specific space interval, resident population information in the specific space interval, or weather information and holiday information in the specific time interval or the specific space interval.

According to an embodiment of the present invention, the gig service prediction system according to spatio-temporal characteristics further includes a gig placement unit receiving spatio-temporal information and the number of gigs assigned to the spatio-temporal information from a first terminal, and generating gig placement data based on the spatio-temporal information and the number of gigs.

According to an embodiment of the present invention, the gig service prediction system according to spatio-temporal characteristics further includes an update unit for updating the prediction data and the service load rate, based on the gig placement data.

According to an embodiment of the present invention, the gig service prediction system further includes a gig reservation unit receiving spatio-temporal information and gig service information to be provided to the spatio-temporal information from a second terminal, and generating gig reservation data based on the spatio-temporal information and the gig service information.

According to an embodiment of the present invention, the gig service prediction system further includes an update unit for updating the prediction data and the service load rate based on the gig reservation data.

### Advantageous Effects

The gig service prediction system according to the present invention can predict the number of gig service requests to occur at a specific time band or in a specific space interval and the number of gigs to provide the gig service. By providing a service load rate representing a predicted number of gig service requests in comparison to a predicted number of gigs, the gig service prediction system can easily identify whether or not the number of gigs is insufficient for the specific time band or the specific space interval.

Therefore, a gig service provider can reduce his/her waiting time for a gig service request to be provided by selecting a time band or a region where the number of gigs is insufficient, and due to such a reduced waiting time, maximize his/her profits from providing the gig service. Further, since it is possible to efficiently select the time and space to provide the gig service as needed, the gig service provider has the advantage of facilitating his/her time management.

The gig service manager may determine the time or region in which the number of gigs is too high or low, so that the gigs can be properly arranged. Therefore, it has the advantage of reducing operational waste of gig services and maximizing the efficiency of gig services performance.

Further, since a gig service requester can be served with the gig service within a designated time scope thanks to the appropriate placement of the gig as needed, it will result in increased satisfaction with the gig service.

### BRIEF DESCRIPTION OF THE DRAWINGS

FIG. 1 is a schematic diagram illustrating an example of configuration of a gig service prediction system according to an embodiment of the present invention.

FIG. 2 shows an example of a gig service prediction method according to an embodiment of the present invention in detail.

FIG. 3 is a schematic block diagram of a gig service server according to an embodiment of the present invention.

FIG. 4 shows an example of a gig service prediction method according to an embodiment of the present invention in detail.

FIG. 5 shows a schematic flowchart of a gig service prediction method according to an embodiment of the present invention.

### MODE FOR CARRYING OUT THE INVENTION

Hereinafter, preferred embodiments of the present disclosure will be described in detail with reference to the accompanying drawings. Throughout the drawings, like or same reference numerals refer to like or same elements, and the size of each component therein may be exaggerated or reduced for better clarity of description.

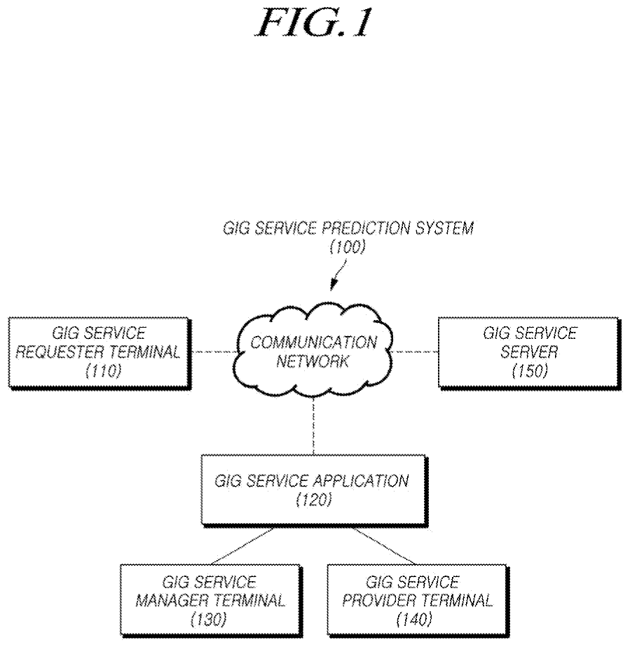

FIG. 1 is a schematic block diagram of an example of a gig service prediction system according to an embodiment of the present invention.

A gig service prediction system 100 according to an embodiment of the present invention includes a gig service requester terminal 110, a gig service application 120, a gig service manager terminal 130, a gig service provider terminal 140, and a gig service server 150.

The gig service server 150 may obtain gig service request data generated in a preset time interval or a preset space interval from the gig service requester terminal 110, in order to predict the number of gig service requests to occur in the future. There may be a plurality of gig service requester terminals 110. The greater being the number of gig service requester terminals and the more accumulated being the gig service request data, the higher accuracy of prediction of the number of gig service requests may be obtained. The gig service request data may include at least one of service type, such as e.g., delivery agency and cleaning agency, time of request for gig service, a region where a gig service was requested, information about a service management spot that assign a gig for a requested gig service, service requester information, history information of a service requester, or service feedback information. The service requester's history information may include a service request pattern such as e.g., the service requester's preferred time band and region, preferred service type, etc., and the service feedback information may include information about completion of the requested gig service, a level of satisfaction of the gig service, intention to re-request the same gig service, or the like.

The gig service server 150 may use the gig service request data to generate prediction data on the number of gig service requests that is expected to occur in a preset time interval or a preset space interval. The time interval may be set by units of hour, day, month, or year, and the space interval may be set from a space interval distinguished by a road/street address up to a larger city area such as e.g., Seoul City or Busan City.

Further, the gig service server 150 may increase the accuracy of prediction data by combining external data. The external data may include at least one of topographical information of a space interval, resident population information of space interval, weather information, or holiday information in a certain time interval or space interval.

For example, the gig service server 150 may predict the type of gig service and the number of gig services to be requested in the vicinity of a certain university in the morning time band of a coming weekend, based on the type of gig services and the number of gig services requested in the vicinity of the university district every weekend morning for a period of one year. At this time, if the university is a women's college/university, the type of gig service requested may be different because the proportion of women among the resident population may be relatively higher. Further, as many people are more likely to refrain from going out and make order for a delivery food on rainy days, the number of gig service requests for delivery agencies may increase in comparison to any other non-rainy days.

In such a way, the type or number of requested gig services may vary depending on any external factors such as e.g., resident population information, weather condition, or the like. In this context, the gig service server 150 may reflect such external data to generate more accurate prediction data.

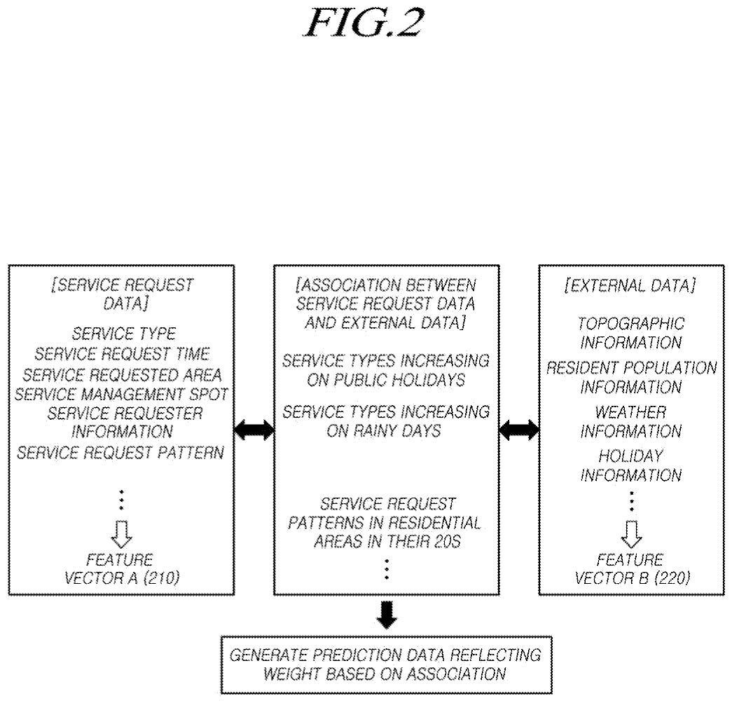

FIG. 2 illustrates an example of a gig service prediction method according to an embodiment of the present invention in a more specific manner, for generating prediction data by reflecting a weight based on the degree of association between the service request data and the external data.

The gig service server 150 may generate vectors 210 and 220 representing attribute values of service request data and attribute values of external data. The gig service server 150 may learn the degree of association between the service request data and the external data, based on the vector 210 representing the feature of the service request data and the vector 220 representing the feature of the external data. Further, the gig service server 150 may generate prediction data to which a weight for each attribute is assigned, based on the learned degree of association.

For example, the gig service server 150 may learn that the number of gig service requests for food delivery service from college/university districts is usually getting higher on weekend mornings than on weekdays, and determine the degree of association between college/university districts and weekends. Assigning weights to the number of service requests so that the expected number of service requests increases based on the degree of relevance makes it possible to predict that more gig service requests will occur on weekend mornings in college/university districts.

The prediction method used by the gig service server 150 makes it possible to make a prediction by finding a specific pattern appearing in the past service request history using a conventional pattern recognition technique. Further, the gig service server 150 may generate the prediction data using various neural network technologies such as e.g., LSTM (Long Short-Term Memory Models), but it will be apparent to those skilled in the art that the disclosure is not limited to such a specific prediction method.

In the meantime, even if the number of gig service requests is predicted, and if the number of gigs (gig workers) to provide the corresponding gig service cannot be predicted, it will be uncertain whether the requested service will be properly performed. Therefore, it is necessary to predict the number of gigs to provide the service for a specific time band or a specific space interval, so that the gigs can be efficiently placed based on the predicted number of gig service requests. As such, the gig service server 150 may predict the number of gigs to provide the corresponding gig service in a specific time interval or a specific space interval.

The gig service server 150 may obtain gig service completion data from the gig service application 120 in order to predict the number of gigs. The gig service application 120 may receive the gig service completion data from the gig service provider terminal 140 or the gig service manager terminal 130. Further, the gig service server 150 may obtain the gig service completion data from the gig service requester terminal 110.

The gig service completion data may include at least one of the type of gig service completed, the time of the gig service requested, the region where the gig service was requested, the time of the gig service completed, the time allocated to the gig assignment after the gig service was requested, and the assigned gig information, history information of the assigned gig, a service management spot for assigning a gig for a requested gig service, and service feedback information. The assigned gig information or history information of the assigned gig may include gig service provision patterns such as a time and/or a region for providing the gig service, preferred service type, etc., and the service feedback information may include the degree of requester's satisfaction with the gig service, etc.

The gig service server 150 may use at least one of the gig service request data and the gig service completion data to predict the expected number of gigs at a specific time and in a specific area. Further, the gig service server 150 may obtain access history data of the gig service provider terminal 140 in a preset time interval or a preset space interval and/or data on gig competition rates in the preset time interval or the preset space interval from the gig service manager terminal 130, thereby predicting the expected number of gigs at a specific time and in a specific area.

At this time, the gig service server 150 may analyze the degree of association between the external data and the gig service request data, or the external data and the gig service completion data, and increase the accuracy by assigning weights to the prediction data for the number of gigs, based on the above analysis. The method of increasing the accuracy by means of assigning the weights may be substantially the same, in operation, as that of assigning weights when predicting the number of gig service requests as described above.

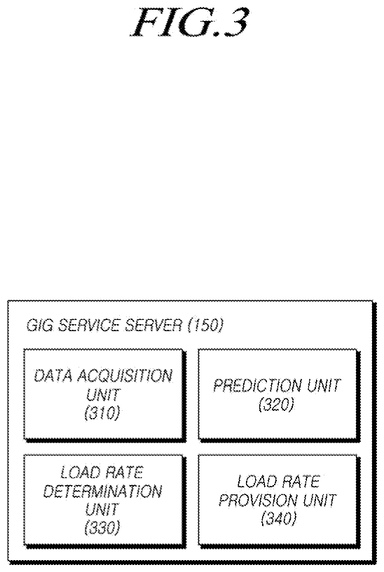

FIG. 3 is a schematic block diagram of an example of a gig service server according to an embodiment of the present invention. Hereinafter, referring to FIG. 3, a gig service server 150 will be described in more detail.

The gig service server 150 according to an embodiment of the present invention includes a data acquisition unit 310, a prediction unit 320, a load rate determination unit 330, and a load rate provision unit 340.

As described above, the data acquisition unit 310 may obtain gig service request data and gig service completion data generated in a preset time interval or a preset space interval. The data acquisition unit 310 may obtain data from the gig service requester terminal 110 or the gig service application 120.

The prediction unit 320 may use at least one of the obtained gig service request data and gig service completion data to generate prediction data on the number of gig service requests to arise in a specific time interval or specific space interval and the number of gig personnel to provide the gig service. The prediction unit 320 may analyze a degree of association between at least one of the gig service request data and the gig service completion data and external data, and based on the degree of association, assign weights to the prediction data on the number of gig service requests to occur in a specific time interval or specific space interval and the number of gigs to provide the gig service. The prediction unit 320 may increase the accuracy of the prediction data by assigning weights using external data.

The load rate determination unit 330 may determine a service load rate representing the number of gig service requests in comparison to the number of gigs, based on the predicted number of gig service requests and the predicted number of gigs.

Even if the number of gig service requests is predicted, there is a problem in that it may be difficult to provide the requested service in real time if the gigs to provide the corresponding gig service are not appropriately arranged. Therefore, the service load rate represents the expected number of service requests in comparison to the expected number of gigs in a specific time interval or a specific space interval, and it may be an indicator indicating whether the number of gigs providing services for the gig service requests is appropriately arranged.

The load rate provision unit 340 may transmit the service load rate to an external terminal through the gig service application 120. The external terminal may be a gig service manager terminal 130 or a gig service provider terminal 140.

The gig service manager can easily determine how many gigs are to be arranged at what time or in which area, by means of the gig service load rate, and the gig, who is a gig service provider, can easily determine at what time or in which area to provide his/her gig service.

For example, in a case that the service load rate is relatively high or large, it may imply that the number of service requests is greater than the number of gigs, so more gigs should be deployed. In a case that the service load rate is relatively low or small, it may indicate that the number of service requests is smaller than the number of gigs, so the gigs need to be deployed to different times or in different regions.

Further, the load rate provision unit 340 may provide a service load rate for a specific time and space in various forms. For example, the service load rate may be provided in a percentage form, using the following equation:

(Predicted Number of Service Requests/Predicted Number of Gigs)×100.

When the above service load rate gets closer to 100, it can be seen that the number of service requests in comparison to the expected number of gigs is appropriately arranged. Further, if the service load rate is greater than 100, it may indicate that the predicted number of service requests is greater than the predicted number of gigs, while if it is smaller than 100, it may indicate that the predicted number of service requests is smaller than the predicted number of gigs. It will be apparent to those skilled in the art that the load rate provision unit 340 may represent the service load rate in various ways other than percentage as stated above.

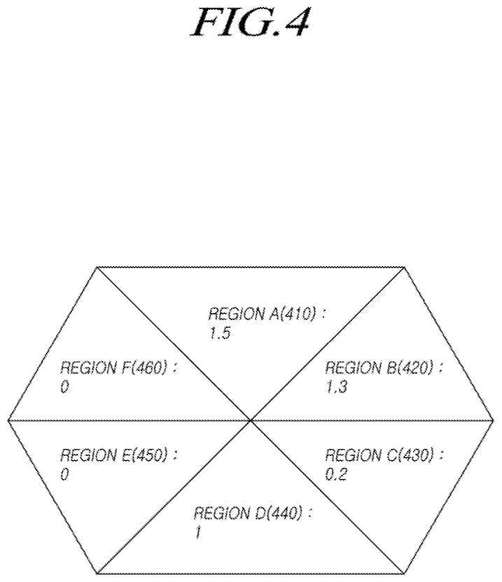

FIG. 4 shows an example of a gig service prediction method according to an embodiment of the present invention in more detail, showing the service load rate for a certain space interval preset in the load rate provision unit 340, in the gig service application 120.

According to FIG. 4, the load rate provision unit 340 is configured to divide a specific district in Seoul City into six regions (regions A to F), wherein for each of the divided regions (410, 420, 430, 440, 450, 460), the number of service requests in comparison to the number of gigs is predicted and represented as a service load rate. Here, the service load rate may be, in an embodiment, calculated with the formular “the predicted number of service requests/the predicted number of gigs”. Therefore, in the case of the region D (440), the predicted number of service requests may be the same as the predicted number of gigs, and thus, it may be expected that the gig service will be smoothly provided.

Meanwhile, the region A (410) and the region B (420) have a larger number of predicted service requests than the predicted number of gigs, and thus, it may be expected that when a gig service is requested in those regions A (410) and B (420), its service provision may be delayed compared to other regions. Therefore, the gig service manager may reinforce the number of gigs by placing more gigs in those regions A (410) and B (420), and the gigs, who are gig service providers, may apply for provision of their gig services in the region A (410) or the regions B (420), thereby providing the gig service without waiting for a gig service request any more.

On the other hand, the predicted number of service requests in comparison to the number of gigs is smaller in the region C (430) and region E (450), so it may take quite a long time for the gigs to wait until a gig service is requested to provide services in the region C (430) and the region E (450). Accordingly, it may be more efficient for some gigs (gig service providers) to select a region with a relatively smaller number of gigs, such as the regions A (410) or region B (420), as his/her service providing region.

In particular, in the region where there is no expected service request, such as region F (460), the gig service manager may increase gig service efficiency by deploying gigs, which are gig service providers, to other region or by deploying only the minimum number of gigs therein.

Although not shown in FIG. 3, the gig service server 150 may further include at least one of a gig placement unit, an update unit, and a gig reservation unit.

The gig placement unit is configured to receive spatio-temporal information and gig worker information assigned to the spatio-temporal information from a first terminal, and generate gig placement data based on the received information. The spatio-temporal information may be information about a specific time interval or a specific space interval selected by the first terminal, and the first terminal may be the gig service manager terminal 130. That is, the gig service manager may arrange gigs at a desired time and space, based on the service load rate represented in the gig service application 120. The gig service manager terminal 130 may provide the gig service server 150 with a time interval and a space interval to arrange the gig and the number of gigs through the gig service application 120, and the gig placement unit may generate the gig placement data based on this information.

The update unit is configured to update prediction data of the prediction unit 320 and the service load rate determined by the load rate determination unit 330, based on the gig placement data. For example, by replacing the predicted number of gigs with the gig placement data, the update unit may cause the load rate determination unit 330 to newly determine the service load rate. Thus, it has the advantage that the accuracy of the service load rate gets higher by reflecting the number of currently deployed gigs in the prediction data.

The gig reservation unit is configured to receive spatio-temporal information and gig service information to be provided to the spatio-temporal information, from a second terminal, and generate gig reservation data based on the received information. The spatio-temporal information may be information about a specific time interval or a specific space interval selected by the second terminal, and the second terminal may be the gig service provider terminal 140. That is, a gig, who is a gig service provider, may designate a time or space in which he/she desires to provide the gig service, based on the service load rate represented in the gig service application 120. The gig service provider terminal 140 may provide the gig service server 150 with information about a time interval or a space interval in which he/she desires to provide the gig service through the gig service application 120, and generate gig reservation data in the gig reservation unit of the gig service server 150.

The update unit is configured to update the prediction data of the prediction unit 320 and the service load rate determined by the load rate determination unit 330, based on the gig reservation data. The accuracy of the service load rate can be further increased by reflecting the time information and space information that a gig service provider intends to provide his/her service, to the prediction data.

Further, when provision of the gig service has been completed based on the generated gig reservation data, the update unit is configured to reflect it to the gig service completion data, and update the prediction data of the prediction unit 320 and the service load rate of the load rate determination unit 330. This is to reflect the gig service status in real time, since once the gig service is completed, the number of service requests or the number of available gigs may be adjusted.

In this way, the update unit may reflect, in real time, at least one of the gig service manager's setting, the gig service provider's setting, or the gig service completion status, so that a service load rate with higher accuracy can be provided. Accordingly, the gig service manager can make efficient deployment of gigs, and the gig service provider can provide his/her gig service without delay. Further, the gig service provider can minimize the waiting time for any gig service requests, and thus, the gig service provider will become very economical with such an increased number of service completions for a unit time.

Meanwhile, although not shown in FIG. 3, the gig service server 150 may further include a promotion unit for generating, managing, and providing promotion data based on the service load rate. Here, the promotion may be referred to as an event that controls the cost of a gig service, and may be used to prevent gig service providers from concentrating at a specific time or in a specific region. Therefore, in the case that the service load rate is relatively high (e.g., when the number of gig service requests is larger than the number of gigs), there may be a promotion for increasing the cost of the gig service, while in the case that the service load rate is relatively low (e.g., when the number of gig service requests is smaller than the number of gigs), there may be a promotion for reducing the cost of the gig service. Therefore, the promotion unit may receive information about the promotion from the gig service manager terminal 130 or an external terminal operated by any other online platform company, and provide the gig service application 120 with information on whether to apply the promotion and its detailed information, together with the service load rate. When the promotion is applied, it may have an advantage that gigs can be appropriately placed even in non-preferred regions or non-preferred times. This is because the preference of gig service providers for that gig service can be increased through promotions that increase the corresponding service costs in non-preferred regions or at non-preferred times.

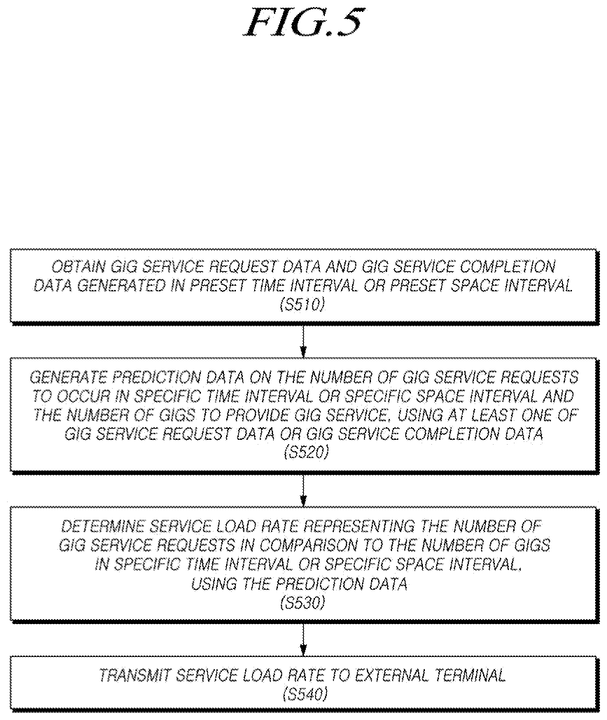

FIG. 5 is a schematic flow chart of a gig service prediction method according to an embodiment of the present invention.

In operation S510, the gig service server 150 obtains gig service request data and service completion data generated in a preset time interval or a preset space interval. The gig service server 150 obtains data from the gig service requester terminal 110 or the gig service application 120.

In operation S520, the gig service server 150 may use at least one of the obtained gig service request data or gig service completion data to generate prediction data on the number of gig service requests to occur in a specific time interval or a specific space interval and the number of gigs to provide the gig service. At this time, the gig service server 150 may analyze a degree of association between at least one of the gig service request data or gig service completion data and an external data, and based on the analyzed degree of association, assign a weight to the prediction data on the number of gig service requests and the number of gigs to provide the gig service to be generated in a specific time interval or a specific space interval.

In operation S530, the gig service server 150 may determine the service load rate representing the number of gig service requests in comparison to the number of gigs in a specific time interval or a specific space interval, using the prediction data. Here, the service load rate represents the expected number of gig service requests in comparison to the expected number of gigs in a specific time interval or a specific space interval, and it may be a kind of indicator indicating whether or not the number of gigs providing the gig service in response to the gig service request is appropriately arranged.

In operation S540, the gig service server 150 may transmit the service load rate to an external terminal through the gig service application 120. The external terminal may be the gig service manager terminal 130, the gig service provider terminal 140, or an external terminal operated by an online platform business company.

Further, the gig service server 150 may receive a selection of a specific time interval or a specific space interval from the gig service manager terminal 130, and receive the number of gigs assigned to the selected time and space to generate gig placement data. Therefore, the gig service server 150 may provide the prediction data with higher accuracy, by updating the prediction data and the service load rate, based on the gig placement data.

Further, the gig service server 150 may receive a selection of a specific time interval or a specific space interval from the gig service provider terminal 140 and generate the gig reservation data for the selected time and space. The gig service server 150 may provide the prediction data with higher accuracy, by updating the prediction data and the service load rate, based on the gig reservation data.

Furthermore, the gig service server 150 may receive the gig completion data including a service completion time after performing the gig service, from the gig service provider terminal 140, to update the prediction data and the service load rate. This is to reflect a change caused in the expected number of gig service requests and the expected number of gigs to provide the gig service when the gig service is completed.

While preferred embodiments of the present invention have been described in detail heretofore, the scope of the present invention is not limited thereto, and various modifications and any other equivalent embodiments are possible. Therefore, the true technical scope of protection of the present invention shall be defined by the appended claims.

For example, a device according to an exemplary embodiment of the present invention may include a bus coupled to units of each apparatus or device as illustrated, at least one processor operatively coupled to the bus, and a memory coupled to the bus to store instructions, received messages, or generated messages, and coupled to the at least one processor to perform the aforementioned instructions.

Further, a system according to the present invention may be implemented with computer-readable codes on a computer-readable recording medium. The computer-readable recording medium may include any kinds of recording devices in which data readable by a computer system is stored. The computer-readable recording medium may include a magnetic storage medium (e.g., ROM, floppy disk, hard disk, etc.) and an optical reading medium (e.g., CD-ROM, DVD, etc.). The computer-readable recording medium may be distributed over a network-connected computer system to store and execute computer-readable codes in a distributed manner.

1. A gig service prediction method according to spatio-temporal characteristics, the method comprising:
obtaining gig service request data and gig service completion data generated in a preset time interval or a preset space interval;
generating prediction data on the number of gig service requests to occur in a specific time interval or a specific space interval and the number of gigs to provide the gig service, using at least one of the gig service request data and the gig service completion data;
determining a service load rate representing the number of gig service requests in comparison to the number of gigs in the specific time interval or the specific space interval, using the generated prediction data; and
transmitting the service load rate to an external terminal.

2. The gig service prediction method of claim 1, wherein the gig service request data includes at least one of service type, service request time, service request area, service management spot, service requester information, history information of the service requester, or service feedback information.

3. The gig service prediction method of claim 1, wherein the gig service completion data includes at least one of service type, service request time, service request area, service completion time, time for gig assignment, assigned gig information, history information of assigned gig, service management spot, or service feedback information.

4. The gig service prediction method of claim 1, wherein generating the prediction data further comprises:
analyzing a degree of association between at least one of the gig service request data and the gig service completion data and external data, and
assigning a weight to the prediction data on the number of gig service requests to occur in the specific time interval or the specific space interval and the number of gigs to provide the gig service, based on the degree of association.

5. The gig service prediction method of claim 4, wherein the external data includes at let one of topographic information of the specific space interval, resident population information in the specific space interval, or weather information and holiday information in the specific time interval or the specific space interval.

6. The gig service prediction method of claim 1, further comprising:
receiving spatio-temporal information and the number of gigs assigned to the spatio-temporal information from a first terminal, and
generating gig placement data based on the spatio-temporal information and the number of gigs.

7. The gig service prediction method of claim 6, further comprising updating the prediction data and the service load rate, based on the gig placement data.

8. The gig service prediction method of claim 1, further comprising:
receiving spatio-temporal information and gig service information to be provided to the spatio-temporal information from a second terminal, and
generating gig reservation data based on the spatio-temporal information and the gig service information.

9. The gig service prediction method of claim 8, further comprising receiving gig completion data including a gig service completion time from the second terminal.

10. The gig service prediction method of claim 9, further comprising updating the prediction data and the service load rate, based on the gig reservation data or the gig completion data.

11. A computer-readable recording medium in which a program for performing the method according to claim 1 is recorded.

12. A gig service prediction system according to spatio-temporal characteristics, the system comprising:
a data acquisition unit obtaining gig service request data and gig service completion data generated in a preset time interval or a preset space interval;
a prediction unit generating prediction data on the number of gig service requests to occur in a specific time interval or a specific space interval and the number of gigs to provide the gig service, using at least one of the gig service request data and the gig service completion data;
a load rate determination unit determining a service load rate representing the number of gig service requests in comparison to the number of gigs in the specific time interval or the specific space interval, using the generated prediction data; and
a load rate provision unit transmitting the service load rate to an external terminal.

13. The gig service prediction system of claim 12, wherein the prediction unit is configured to:
analyze a degree of association between at least one of the gig service request data and the gig service completion data and external data, and
assign a weight to the prediction data on the number of gig service requests to occur in the specific time interval or the specific space interval and the number of gigs to provide the gig service, based on the degree of association.

14. The gig service prediction system of claim 12, further comprising a gig placement unit receiving spatio-temporal information and the number of gigs assigned to the spatio-temporal information from a first terminal, and generating gig placement data based on the spatio-temporal information and the number of gigs.

15. The gig service prediction system of claim 12, further comprising a gig reservation unit receiving spatio-temporal information and gig service information to be provided to the spatio-temporal information from a second terminal, and generating gig reservation data based on the spatio-temporal information and the gig service information.
